(19) United States
(12) Patent Application Publication
(10) Pub. No.: US 2026/0330533 A1
(43) Pub. Date: Oct. 22, 2026

(54) MULTI-CRITERIA RECOMMENDATION METHOD AND APPARATUS USING MULTI-CRITERIA COGNITIVE GRAPH FILTERING

(71) Applicant: UIF (University Industry Foundation), Yonsei University, Seoul (KR)

(72) Inventors: Won-Yong SHIN, Seoul (KR); Jin-Duk PARK, Seoul (KR)

(21) Appl. No.: 19/646,401

(22) Filed: Apr. 13, 2026

(30) Foreign Application Priority Data
Apr. 17, 2025 (KR) 10-2025-0049972

(51) Int. Cl. G06Q 30/0601

(52) U.S. Cl. CPC G06Q 30/06313

(57) ABSTRACT

A multi-criteria recommendation method includes obtaining, from multi-criteria evaluation data including ratings assigned by a user to items according to a plurality of evaluation criteria, a multi-criteria rating matrix composed of user-item ratings for each evaluation criterion; obtaining, from the multi-criteria rating matrix, an inter-item similarity matrix representing relationships among items; obtaining an adjusted inter-item similarity matrix having a smoothed distribution of element values; setting a criterion-specific polynomial item matrix filter having a polynomial form with respect to the adjusted inter-item similarity matrix; obtaining, from a multi-criteria preference matrix obtained from sums of ratings assigned by the user to a plurality of items, a filtered inter-criterion similarity matrix; and obtaining a final predicted rating by cumulatively summing products of a user rating vector constituting one row of the multi-criteria rating matrix, the criterion-specific polynomial item matrix filter, and the filtered inter-criterion similarity matrix, and recommending an item based on the final predicted rating.

### CROSS-REFERENCE TO RELATED APPLICATIONS

This application claims priority under 35 U.S.C. § 119 to Korean Patent Application No. 10-2025-0049972, filed on Apr. 17, 2025, the disclosure of which is hereby incorporated by reference in its entirety.

### BACKGROUND

The present disclosure relates to a multi-criteria recommendation method and apparatus, and more particularly, to a multi-criteria recommendation method and apparatus using multi-criteria cognitive graph filtering.

Recommendation apparatuses have had a significant impact across various industries by providing personalized recommendations. Among these, multi-criteria recommendation systems that utilize detailed evaluations of each item according to various criteria have attracted attention. Compared with conventional single-criterion recommendation systems, multi-criteria recommendation systems have an advantage in that they can more accurately identify users' needs and provide customized items suitable for users. Accordingly, such systems have been increasingly utilized in various online service fields including travel, restaurants, hotels, movies, and music.

However, multi-criteria recommendation systems have a problem in that computational complexity is significantly increased as compared with single-criterion recommendation systems, because multidimensional user feedback including evaluations of each item according to a plurality of different criteria for each user should be processed and analyzed. Accordingly, there is a need for a multi-criteria recommendation technique using filtering on a multi-criteria graph, which is capable of providing rapid recommendations while improving user satisfaction and recommendation accuracy.

### SUMMARY

An object of the present disclosure is to provide a multi-criteria recommendation method and apparatus that are capable of providing rapid recommendations while improving user satisfaction and recommendation accuracy by using a multi-criteria graph filtering technique.

According to an embodiment, a multi-criteria recommendation method includes: obtaining, from multi-criteria evaluation data including ratings assigned by a user to a plurality of items according to a plurality of evaluation criteria, a multi-criteria rating matrix composed of user-item ratings for each of the plurality of evaluation criteria; obtaining, from the multi-criteria rating matrix, an inter-item similarity matrix representing relationships among the plurality of items; obtaining an adjusted inter-item similarity matrix having a smoothed distribution of element values by performing a Hadamard power operation on the inter-item similarity matrix; setting, for each of the plurality of evaluation criteria, a criterion-specific polynomial item matrix filter having a polynomial form with respect to the adjusted inter-item similarity matrix; obtaining, from a multi-criteria preference matrix obtained from sums of ratings assigned by the user to the plurality of items for each of the plurality of evaluation criteria, a filtered inter-criterion similarity matrix in which similarities among evaluation criteria preferred by the user are filtered; and obtaining a final predicted rating by cumulatively summing, for each of the plurality of evaluation criteria, products of a user rating vector constituting one row of the multi-criteria rating matrix, the criterion-specific polynomial item matrix filter, and the filtered inter-criterion similarity matrix, and recommending one or more items based on the final predicted rating.

The multi-criteria rating matrix may be obtained by generating a plurality of criterion-specific evaluation matrices composed of ratings assigned by a plurality of users to respective items for respective evaluation criteria in the multi-criteria evaluation data, and combining the plurality of criterion-specific evaluation matrices.

The inter-item similarity matrix may be obtained by a matrix multiplication of a transpose of the multi-criteria rating matrix and the multi-criteria rating matrix.

The adjusted inter-item similarity matrix may be obtained by raising each element of the inter-item similarity matrix to the power of an adjustment parameter designated according to the criterion-specific polynomial item matrix filter.

The criterion-specific polynomial item matrix filter may be set by searching for a maximum order and coefficients for respective orders such that a frequency response function has a low-pass filtering characteristic required for each criterion.

The criterion-specific polynomial item matrix filter may be set by selecting, from among a plurality of preset polynomial item matrix filters, a polynomial item matrix filter having a frequency response function with a required low-pass filtering characteristic.

Obtaining the filtered inter-criterion similarity matrix may include obtaining, from the multi-criteria evaluation data, a multi-criteria preference matrix calculated from sums of ratings assigned by the user to the plurality of items for respective evaluation criteria, obtaining, from the multi-criteria preference matrix, an inter-criterion similarity matrix representing similarities among preferences of the user for the evaluation criteria, obtaining an adjusted inter-criterion similarity matrix by performing a Hadamard power operation on the inter-criterion similarity matrix, and obtaining the filtered inter-criterion similarity matrix by multiplying the multi-criteria rating matrix and the adjusted inter-criterion similarity matrix.

The multi-criteria preference matrix may be obtained by multiplying each of a plurality of criterion-specific evaluation matrices, each composed of ratings assigned by a plurality of users to respective items for respective evaluation criteria in the multi-criteria evaluation data, by a vector composed of all ones, and combining resulting matrices.

According to an embodiment, a multi-criteria recommendation apparatus includes a memory and a processor configured to execute at least some operations according to a program stored in the memory, wherein the processor is configured to obtain, from multi-criteria evaluation data including ratings assigned by a user to a plurality of items according to a plurality of evaluation criteria, a multi-criteria rating matrix composed of user-item ratings for each of the plurality of evaluation criteria, obtain, from the multi-criteria rating matrix, an inter-item similarity matrix representing relationships among the plurality of items, obtain an adjusted inter-item similarity matrix having a smoothed distribution of element values by performing a Hadamard power operation on the inter-item similarity matrix, set, for each of the plurality of evaluation criteria, a criterion-specific polynomial item matrix filter having a polynomial form with respect to the adjusted inter-item similarity matrix, obtain, from a multi-criteria preference matrix obtained from sums of ratings assigned by the user to the plurality of items for each of the plurality of evaluation criteria, a filtered inter-criterion similarity matrix in which similarities among evaluation criteria preferred by the user are filtered, and obtain a final predicted rating by cumulatively summing, for each of the plurality of evaluation criteria, products of a user rating vector constituting one row of the multi-criteria rating matrix, the criterion-specific polynomial item matrix filter, and the filtered inter-criterion similarity matrix, and recommend one or more items based on the final predicted rating.

### BRIEF DESCRIPTION OF THE DRAWINGS

FIG. 1 is a diagram for explaining a concept of graph filtering.

FIG. 2 illustrates configurations of a multi-criteria recommendation apparatus based on multi-criteria graph filtering according to an embodiment, the configurations being classified according to operations.

FIG. 3 is a diagram for explaining an operation of an item similarity matrix acquisition module of FIG. 2.

FIG. 4 is a diagram for explaining an operation of high-speed graph filtering using a polynomial matrix filter.

FIG. 5 is a diagram for explaining an operating method of the multi-criteria recommendation apparatus of FIG. 2.

FIG. 6 illustrates a multi-criteria recommendation method according to one embodiment.

FIG. 7 is a diagram for explaining a computing environment including a computing device according to an embodiment.

### DETAILED DESCRIPTION OF THE EMBODIMENTS

Hereinafter, specific embodiments of the present disclosure will be described with reference to the accompanying drawings. The following detailed description is provided to facilitate a comprehensive understanding of the methods, apparatuses, and/or systems described herein. However, the present disclosure is not limited thereto and may be embodied in various different forms.

In describing the embodiments of the present disclosure, detailed descriptions of known technologies related to the present disclosure may be omitted when it is determined that such descriptions may unnecessarily obscure the subject matter of the present disclosure. Further, the terms used herein are defined in consideration of functions in the present disclosure and may vary depending on the intent or practice of users or operators. Accordingly, the definitions of such terms should be interpreted based on the contents throughout this specification. The terms used in the detailed description are merely for describing embodiments and are not intended to be limiting.

Unless expressly stated otherwise, singular expressions include plural meanings. As used herein, terms such as “include” or “comprise” are intended to specify the presence of stated features, numbers, steps, operations, elements, parts, or combinations thereof, and should not be construed as excluding the presence or addition of one or more other features, numbers, steps, operations, elements, parts, or combinations thereof. In addition, terms such as “unit,” “device,” “module,” and “block” refer to a component configured to perform at least one function or operation, and may be implemented by hardware, software, or a combination of hardware and software.

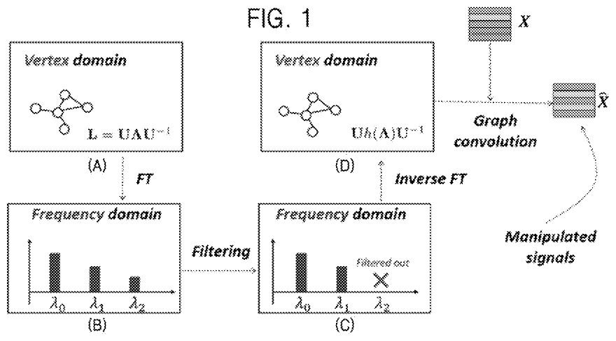

FIG. 1 is a diagram for explaining a concept of graph filtering.

A core technique of a recommendation apparatus is collaborative filtering (CF), which is a method for predicting each user's preference for various items based on past item interaction records of multiple users. Conventionally, collaborative filtering has mainly employed Graph Convolutional Networks (GCNs). A GCN recommends an item suitable for a user by performing neural network operations on a graph including a plurality of users and items as nodes and a plurality of edges connecting the nodes according to relationships between the users and the items. Recently, however, rapid changes in user preferences and a high influx of new data have made the model update speed of a recommendation apparatus increasingly important. Nevertheless, GCN-based collaborative filtering methods have limitations in that they are difficult to apply to changes in user preferences or newly incoming data, because offline training on a massive amount of data should be performed in advance in order to carry out the neural network operations.

To address such problems, graph filtering (GF)-based collaborative filtering methods have recently been proposed. Graph filtering-based collaborative filtering is a method of efficiently obtaining items to be recommended to a user by treating a strength of an edge connected to each node of a graph similarly to a signal in a communication system and performing filtering to adjust the strength of the edge, that is, a connection relationship between nodes. In general, a graph filtering-based collaborative filtering method applies a low-pass filter (LPF) to a graph so that relationships between users and items are smoothly correlated with each other, thereby enabling recommendation of items without using a neural network that requires training.

Given a weighted graph G=(V, E) including a node set V and an edge set E, a graph Laplacian matrix L for the graph G may be represented as a difference between a degree matrix D and an adjacency matrix A, that is, L=D−A.

The adjacency matrix A is a symmetric matrix representing connection relationships, that is, edges, between different nodes in the graph. The degree matrix D is a diagonal matrix having, as diagonal elements, the numbers of edges connected to respective nodes of the graph G, and having 0 as remaining elements, and may be represented as D=diag(A1). Here, 1 denotes a |V|-dimensional vector in which all elements are 1. Accordingly, the graph Laplacian matrix L may be configured as a symmetric matrix in which elements other than the diagonal elements have values of 0 or negative values.

Further, as shown in (A) of FIG. 1, a graph represented by the graph Laplacian matrix L may be decomposed into L=UΛU⁻¹ through eigen-decomposition for analyzing eigenvalues and eigenvectors. Here, Λ is an eigenvalue matrix having, as diagonal elements, eigenvalues (λ₁, λ₂, . . . , λ_{|V|}) respectively corresponding to the |V| nodes included in the node set V, and may be expressed as Λ=diag(λ₁, λ₂, . . . , λ_{|V|}). U is an eigenvector matrix having columns corresponding to an eigenvector set of the graph Laplacian matrix L, and U⁻¹ is an inverse matrix of the eigenvector matrix U.

Meanwhile, a graph signal (x) obtained by converting the graph G into a signal may be represented as |V|-dimensional vector format, that is (x=[x₁, x₂, . . . , x_{|V|}]^{T}), composed of signal strength (or values) respectively corresponding to |V| nodes of the node set V. Since the graph Laplacian matrix L is eigen-decomposed into an eigenvalue matrix Λ and an eigenvector matrix U, a Fourier transform (FT) of the graph signal (x) may be defined as \hat{x}=U^{T}x. Here, U^{T} denotes a transpose of the eigenvector matrix U. That is, the eigen-decomposition of the graph Laplacian matrix L may be understood as an operation similar to performing a Fourier transform on the graph signal (x), as shown in (B) of FIG. 1.

A graph filter H(L) applied to the graph Laplacian matrix L may be defined by Equation 1.

H(L)=Udiag(h(λ₁), . . . ,h(λ_{|V|}))U^{T} (1)

Here, h denotes a frequency response function for mapping eigenvalues {λ₁, λ₂, . . . , λ_{|V|}} of the graph Laplacian matrix L to {h(λ₁), h(λ₂), . . . , h(λ_{|V|})}.

Since graph filtering may be performed by combining the graph signal (x) with the graph filter H(L), graph filtering may be defined by Equation 2.

H(L)x=Udiag(h(λ₁), . . . ,h(λ_{|V|}))U^{T}x (2)

In this case, a smoothness S(x) of the graph signal (x) with respect to the graph G may be quantified as S(x)=Σ_{i,j}A_{i,j}(xᵢ−xⱼ)²=x^{T}Lx. Here, A_{i,j} denotes an (i,j)-th element of the adjacency matrix A, and xᵢ denotes a signal strength of an i-th node in the graph signal (x). Accordingly, the smaller S(x), the smoother the graph signal (x).

As described above, a graph filtering-based collaborative filtering technique mainly uses a low-pass filter, which, as shown in (C) of FIG. 1, may be regarded as an operation of leaving only some eigenvalues among eigenvalues {λ₁, λ₂, . . . , Δ_{|V|}} of the graph Laplacian matrix L and removing high-order eigenvalues by filtering. Accordingly, as shown in (D) of FIG. 1, by setting a filtering function h(Λ) applied to an eigenvalue matrix Λ={λ₁, λ₂, . . . , λ_{|V|}} of the eigen-decomposed graph Laplacian matrix L such that a frequency response in which high-order eigenvalues are removed from the eigenvalues {λ₁, λ₂, . . . , λ_{|V|}} is derived, and applying Uh(Λ)U⁻¹, low-pass filtering may be performed on the graph G.

However, in the case of a graph filtering-based collaborative filtering technique, the graph filter H(L) is set to be an ideal low-pass filter, and, in this process, a high computational cost for matrix decomposition is required. In order to reduce such a high computational cost, high-speed graph filtering has been proposed in which filtering is performed by configuring a polynomial low-pass filter (Polynomial LPF) having a polynomial matrix form, without using matrix decomposition.

However, graph filtering and high-speed graph filtering are techniques designed for single-criterion recommendation, and are not suitable for application to multi-criteria recommendation.

Accordingly, an embodiment proposes a multi-criteria graph filtering technique, and discloses a multi-criteria recommendation method and apparatus according to the proposed multi-criteria graph filtering technique.

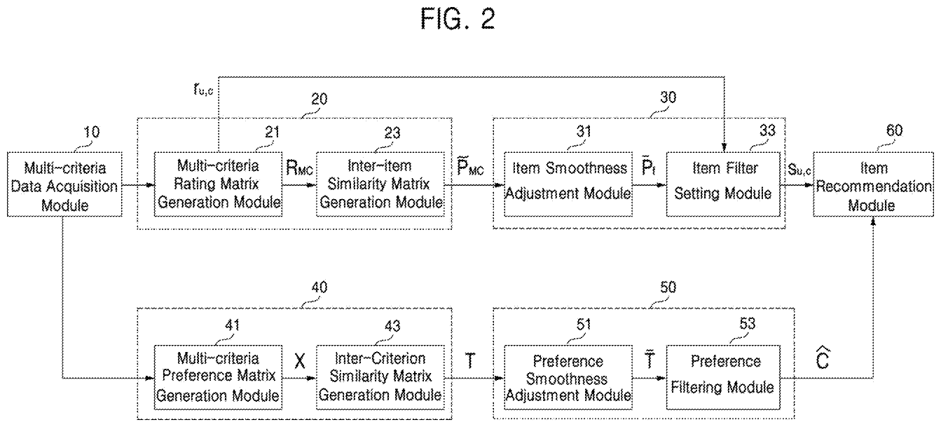

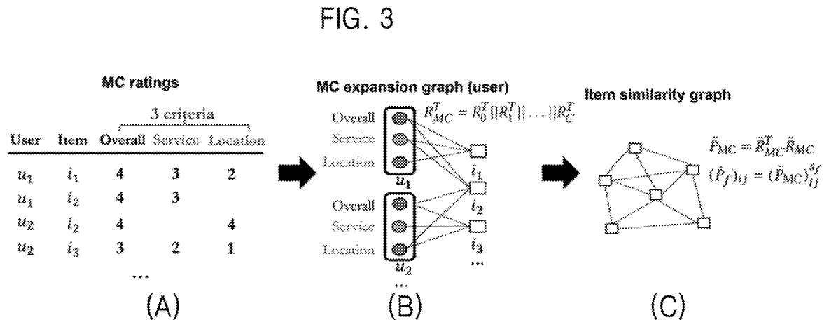

FIG. 2 illustrates configurations of a multi-criteria recommendation apparatus based on multi-criteria graph filtering according to an embodiment, the configurations being classified according to operations, and FIG. 3 is a diagram for explaining an operation of an item similarity matrix acquisition module of FIG. 2.

Referring to FIG. 2, a multi-criteria recommendation apparatus according to an embodiment may include a multi-criteria data acquisition module 10, an item similarity matrix acquisition module 20, an item filter module 30, a multi-criteria similarity matrix acquisition module 40, a preference filter module 50, and an item recommendation module 60.

The multi-criteria data acquisition module 10 collects multi-criteria rating data in which a plurality of users (User) evaluate a plurality of items (Item) according to each of a plurality of criteria. Here, the multi-criteria rating data may include a user identifier, an item identifier, and a plurality of criterion-specific rating scores. Here, the plurality of criteria to which the criterion-specific rating scores are assigned may differ from one another in type and number according to the plurality of items. For convenience of description, as a simple example, it is assumed herein that, as shown in (A) of FIG. 3, in a case where an item is a hotel or a restaurant, item information such as service (Service) and location (Location) is included in the multi-criteria rating data as criterion-specific rating scores according to respective criteria (c, c∈C).

In addition to the criterion-specific rating scores (c), an overall rating (Overall) score for an item may also be included together in the multi-criteria rating data, as in a conventional single-criterion rating. Since the overall rating score is also a rating according to a criterion corresponding to the entirety of the item, for convenience of description, it is assumed herein that the overall rating score is also included in the criterion-specific rating scores. Accordingly, the criterion-specific ratings for each item may be configured to include (C+1) ratings, that is, the number of individual criteria C plus the overall rating (here, in FIG. 3, 2+1=3).

The item similarity matrix acquisition module 20 acquires an inter-item similarity matrix (\tilde{P}_{MC}, also referred to as an item-to-item similarity matrix) representing similarity between items from the multi-criteria rating data collected by the multi-criteria data acquisition module 10.

The item similarity matrix acquisition module 20 may include a multi-criteria rating matrix generation module 21 and an inter-item similarity matrix generation module 23. The multi-criteria rating matrix generation module 21 receives multi-criteria rating data and, as shown in (B) of FIG. 3, generates (C+1) criterion-specific rating matrices (R₀, R₁, . . . , R_{C}) in which a plurality of users (u₁, u₂, . . . ) rate respective items (i₁, i₂, i₃, . . . ) for each criterion (c), and obtains a multi-criteria rating matrix R_{MC} by concatenating the generated (C+1) criterion-specific rating matrices (R₀, R₁, . . . , R_{C}) as shown in Equation 3.

$${R}_{MC}^{T} = {R}_{0}^{T} ‖ {R}_{1}^{T} ‖ … ‖ {R}_{C}^{T} \qquad ( 3 )$$

Here, T denotes denotes matrix transposition, and ∥ denotes a concatenation function.

Since the criterion-specific rating matrices (R₀, R₁, . . . , R_{C}) each have a size of [symbol] ^{|} [symbol] ^{|×|I|}, the multi-criteria rating matrix R_{MC} is generated as a matrix having a size of [symbol] ^{(C+1)|} [symbol] ^{|×|I|}.

And the multi-criteria rating matrix generation module 21 may obtain a normalized multi-criteria rating matrix \tilde{R}_{MC} by by performing normalization on the generated multi-criteria rating matrix R_{MC} as shown in Equation 4.

$$\text{?} = {D}_{U}^{- 1 / 2} {R}_{MC} {D}_{I}^{- 1 / 2} \qquad ( 4 )$$

$$\text{?} \text{indicates text missing or illegible when filed}$$

Here, D_{U} and D_{I} are diagonal matrices of criterion-user nodes and item nodes, respectively, in the multi-criteria rating matrix R_{MC}, and are obtained as D_{U}=diag(R_{MC}l) and D_{I}=diag(l^{T}R_{MC}), where l denotes denotes a vector composed of elements of 1.

The reason why the multi-criteria rating matrix generation module 21 performs normalization on the multi-criteria rating matrix R_{MC} is that, unlike the graph Laplacian matrix L in which nodes of a graph are not divided into different groups, in the multi-criteria rating matrix R_{MC}, nodes of the graph are divided into a user group and an item-specific criterion group, and thus the normalization is performed in order to adjust mutual influence between users and item-specific criteria. Here, it is assumed that symmetric normalization in which the mutual influence is identical is performed, and thus the normalization is performed using D_{U}^{-1/2} and D_{I}^{-1/2}.

In some cases, the multi-criteria rating matrix generation module 21 may not perform normalization on the multi-criteria rating matrix R_{MC}. However, since obtaining the normalized multi-criteria rating matrix \tilde{R}_{MC} results in further improved performance, a case in which normalization is performed is assumed and described herein.

The inter-item similarity matrix generation module 23 may receive the normalized multi-criteria rating matrix \tilde{R}_{MC} obtained by the multi-criteria rating matrix generation module 21, and may obtain an inter-item similarity matrix \tilde{P}_{MC} representing similarity between a plurality of items according to Equation 5.

$$\text{?} = \text{?} \qquad ( 5 )$$

$$\text{?} \text{indicates text missing or illegible when filed}$$

Since the multi-criteria rating matrix R_{MC} is a matrix having a size of [symbol] ^{(C+1)|} [symbol] ^{|×|} [symbol] ^{|} and representing a user-rating relationship in which rows and columns are classified according to users and item-specific criteria, a matrix multiplication of a transpose of the normalized multi-criteria rating matrix \tilde{R}_{MC} and the normalized multi-criteria rating matrix \tilde{R}_{MC} is obtained as an inter-item similarity matrix \tilde{P}_{MC} having a size of ( [symbol] ^{|I|×|I|}) and representing a relationship between items according to users and criterion-specific ratings.

The inter-item similarity matrix \tilde{P}_{MC} may be converted into an item similarity graph in which a plurality of items constitute respective nodes and weights of edges connecting the nodes have mutual similarity, as shown in (C) of FIG. 3.

The item filter module 30 obtains a polynomial item matrix filter (f(·)) to be applied to the inter-item similarity matrix \tilde{P}_{MC} obtained by the item similarity matrix acquisition module 20. The polynomial item matrix filter (f(·)) denotes a matrix filter for performing low-pass filtering on a matrix, corresponding to a graph filter that performs low-pass filtering on a graph.

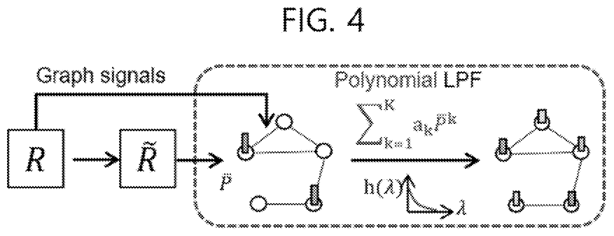

FIG. 4 is a diagram for explaining a concept of high-speed graph filtering using a polynomial matrix filter.

In FIG. 4, for convenience of understanding, a single-criterion rating matrix R, rather than a multi-criteria rating matrix, is taken as an example, and a case is illustrated in which polynomial matrix filtering is performed on a normalized rating matrix \tilde{R} obtained by normalizing the rating matrix R.

Referring to FIG. 4, in the case of general graph filtering, eigenvalue decomposition is performed on a rating matrix R to obtain eigenvalues ({λ₁, λ₂, . . . , λ_{|V|}}), and a frequency response function (h(λ)) for each of the eigenvalues ({λ₁, λ₂, . . . , λ_{|V|}}) is searched for so that only some of the obtained eigenvalues ({λ₁, λ₂, . . . , λ_{|V|}}) remain. Then, low-pass filtering is performed by applying the searched frequency response function (h(λ)) for each of the eigenvalues ({λ₁, λ₂, . . . , λ_{|V|}}) to a graph signal derived from the rating matrix R. That is, low-pass filtering is performed by obtaining a filtering function (h(Λ)) composed of the frequency response functions (h(λ)) searched for with respect to the respective eigenvalues ({λ₁, λ₂, . . . , λ_{|V|}}) of the rating matrix R. In this process, eigenvalue decomposition of the single-criterion rating matrix R should first be performed.

However, in the case of a high-speed graph filtering technique using a polynomial matrix filter, an inter-item similarity matrix \tilde{P} may be obtained from the rating matrix R, and a matrix filter in a polynomial form (here,

$$\text{?} = {\sum }_{k = 1}^{K} {a}_{k} \text{?} )$$

$$\text{?} \text{indicates text missing or illegible when filed}$$

) for performing filtering on the rating matrix R based on the inter-item similarity matrix \tilde{P} may be easily obtained. Further, low-pass filtering on the rating matrix R may be performed by an operation of multiplying the obtained matrix filter f(\tilde{P}_{f}) by a vector (rᵤ) of the rating matrix R. Accordingly, graph filtering may be performed without performing eigenvalue decomposition on the rating matrix R. Since this is a known technique, a detailed description thereof will be omitted herein.

However, the item filter module 30 according to an embodiment should obtain a polynomial item matrix filter (f(·)) to be applied to the multi-criteria rating matrix R_{MC}, rather than to the single-criterion rating matrix R. Accordingly, the item filter module 30 obtains the polynomial item matrix filter (f(·)) based on the inter-item similarity matrix \tilde{P}_{MC} obtained from the multi-criteria rating matrix R_{MC}.

The item filter module 30 may include an item smoothness adjustment module 31 and an item filter setting module 33.

The item smoothness adjustment module 31 receives the inter-item similarity matrix \tilde{P}_{MC} and adjusts smoothness of the inter-item similarity matrix \tilde{P}_{MC}. The item smoothness adjustment module 31 adjusts strengths of edges connecting items in an item similarity graph, thereby obtaining an adjusted inter-item similarity matrix \tilde{P}_{f}. As described above, the recommendation apparatus according to an embodiment performs filtering according to a graph filtering technique based on a low-pass filter. In this process, the inter-item similarity matrix \tilde{P}_{MC} may be over-smoothed or under-smoothed. When the inter-item similarity matrix \tilde{P}_{MC} is over-smoothed or under-smoothed, strengths of similarities representing relationships between items become similar in magnitude. When the strengths of similarities become similar in magnitude, differences between the items are not prominent, and thus it may become difficult to recommend a specific item suitable for a user. In order to solve such a problem, the item smoothness adjustment module 31 adjusts element values in advance before the inter-item similarity matrix \tilde{P}_{MC} is filtered, thereby obtaining the adjusted inter-item similarity matrix P̅_{f}.

The item smoothness adjustment module 31 may obtain the adjusted inter-item similarity matrix P̅_{f} by applying a Hadamard power to the inter-item similarity matrix \tilde{P}_{MC} so that weights of edges connecting items in the inter-item similarity matrix \tilde{P}_{MC} are differently adjusted according to the polynomial item matrix filter (f(·)) to be used by the item filter setting module 33. The item smoothness adjustment module 31 may smooth the inter-item similarity matrix \tilde{P}_{MC} according to Equation 6 to obtain the adjusted inter-item similarity matrix \tilde{P}_{f}.

$$\text{?} = \text{?} \qquad ( 6 )$$

$$\text{?} \text{indicates text missing or illegible when filed}$$

Here, ij denotes an element at an (i, j) position of the inter-item similarity matrix \tilde{P}_{MC} and the adjusted inter-item similarity matrix P̅_{f}, and s_{f} is an adjustment parameter.

That is, a smoothed adjusted inter-item similarity matrix P̅_{f} may be obtained by performing a Hadamard power in which elements of the adjusted inter-item similarity matrix P̅_{f} are each raised to the power of the adjustment parameter (s_{f}). Here, the adjustment parameter (s_{f}) may be set based on an element distribution of the inter-item similarity matrix \tilde{P}_{MC}, but may also be set according to the polynomial item matrix filter (f(·)). For example, when the polynomial item matrix filter (f(·)) is a first-order linear function, the adjustment parameter (s_{f}) may be set according to the element distribution of the inter-item similarity matrix \tilde{P}_{MC} within a range of 0<s_{f}≤1, and when the polynomial item matrix filter (f(·)) is a higher-order function of second order or more, the adjustment parameter (s_{f}) may be set by being empirically adjusted according to the element distribution of the inter-item similarity matrix \tilde{P}_{MC} within a range of s_{f}>1.

The item filter setting module 33 receives the adjusted inter-item similarity matrix P̅_{f} and sets, from the received adjusted inter-item similarity matrix P̅_{f}, a criterion-specific polynomial item matrix filter f(P̅_{f}),c) for each evaluation criterion (c).

A normalized graph Laplacian matrix \tilde{L} for the adjusted inter-item similarity matrix P̅_{f} may be expressed as \tilde{L}=I−P̅_{f}. For the normalized graph Laplacian matrix \tilde{L} corresponding to the adjusted inter-item similarity matrix P̅_{f}, there exists an orthogonal eigendecomposition based on an orthogonal matrix Ũ, i.e., \tilde{L}=ŨΛŨ^{T}, where ŨŨ^{T}=ŨTŨ=I.

Since the normalized graph Laplacian matrix \tilde{L} is eigendecomposed as \tilde{L}=ŨΛŨ^{T} based on the orthogonal matrix, eigenvalues of the normalized graph Laplacian matrix L, for example, the eigenvalues ({λ₁, λ₂, . . . , λ_{|V|}}), may be manipulated in the form of a polynomial such as \tilde{L}²=ŨΛ²Ũ^{T}, without performing a matrix decomposition that requires high computational cost. That is, without performing matrix decomposition, a low-pass filter may be configured by manipulating the eigenvalues ({λ₁, λ₂, . . . , λ_{|V|}}) of the normalized graph Laplacian matrix \tilde{L} such that a frequency response exhibits a low-pass filtered characteristic.

The item filter setting module 33 may set a criterion-specific polynomial item matrix filter f(P̅_{f,c}) for low-pass filtering as shown in Equation 7.

$$f ( \text{?} , c ) = {\sum }_{k = 1}^{K} {a}_{c , k} \text{?} \qquad ( 7 )$$

$$\text{?} \text{indicates text missing or illegible when filed}$$

Here, a_{c,k} denotes a coefficient for each order (k) with respect to the evaluation criterion (c), and K denotes a maximum order of a matrix polynomial base.

A criterion-specific frequency response function (h(l)) for the criterion-specific polynomial item matrix filter f(P̅_{f,c}) of Equation 7 is represented by Equation 8.

$$h ( λ ) = {\sum }_{k = 1}^{K} {{a}_{c , k} ( 1 - λ )}^{k} \qquad ( 8 )$$

The item filter setting module 33 adjusts the maximum order (K) and and the order-specific coefficients (a_{c,k}) of the criterion-specific polynomial item matrix filter f(P̅_{f,c}) of Equation 8, and determines whether the criterion-specific frequency response function (h(l)) of Equation 8 has a required low-pass filtering characteristic. When the criterion-specific frequency response function (h(l)) has the required low-pass filtering characteristic, the criterion-specific polynomial item matrix filter f(P̅_{f,c}) may be set using the maximum order K and the order-specific coefficients (a_{c,k}) at that time. That is, when a required low-pass filtering characteristic is preset for each criterion, the criterion-specific polynomial item matrix filter f(P̅_{f,c}) may be set by searching for the maximum order K and the order-specific coefficients (a_{c,k}) capable of providing the preset low-pass filtering characteristic for the corresponding criterion. Accordingly, the criterion-specific polynomial item matrix filter f(P̅_{f,c}) may be variously preset in advance according to a plurality of predefined low-pass filtering characteristics.

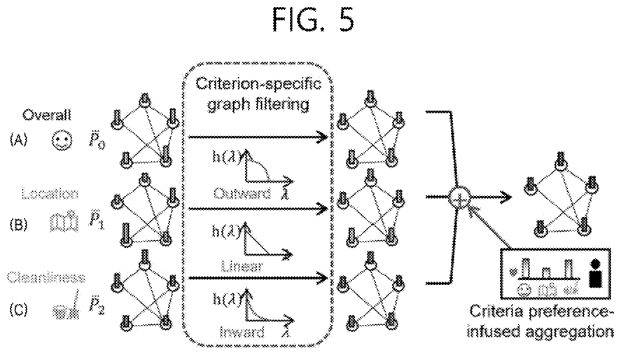

FIG. 5 is a diagram for explaining an operating method of the multi-criteria recommendation apparatus of FIG. 2.

In the multi-criteria recommendation apparatus, the item filter module obtains, for each evaluation criterion (c), a polynomial item matrix filter f(P̅_{f,c}) for filtering a multi-criteria rating matrix R_{MC}, in which a plurality of users evaluate a plurality of items according to three evaluation criteria, namely, Overall, Location, and Cleanliness, as shown in (A) to (C) of FIG. 5.

The criterion-specific evaluation matrices (R₀, R₁, . . . , R_{C}) included in the multi-criteria rating matrix R_{MC} are then filtered using the obtained polynomial item matrix filter f(P̅_{f,c}). Since the polynomial item matrix filter f(P̅_{f,c}) is basically configured to perform low-pass filtering, values of respective nodes in the filtered criterion-specific evaluation matrices (R₀, R₁, . . . , R_{C}) become smoothed, as shown on the right side. This enables acquisition of, for each evaluation criterion, not only ratings for items to which a user has already assigned ratings, but also predicted ratings for items to which the user has not yet assigned ratings. Further, the multi-criteria recommendation apparatus aggregates the filtering results for the respective evaluation criteria to obtain a predicted rating in which all evaluation criteria are considered, thereby determining an item to be recommended to the user.

At this time, the item filter setting module 33 is configured to set the criterion-specific polynomial item matrix filters f(P̅_{f,c}) corresponding to the respective evaluation criteria such that the criterion-specific polynomial item matrix filters f(P̅_{f,c}) may have different low-pass filtering characteristics from one another, thereby improving recommendation performance.

In FIG. 5, low-pass filtering characteristics according to three different criterion-specific polynomial item matrix filters f(P̅_{f,c}) are illustrated as a simple example.

In FIG. 5, among the three evaluation criteria, a first polynomial item matrix filter f(P̅_{,}0) for Overall may be set to have an outward-type frequency response function (h(λ)=1-λ²)), as shown in (A) of FIG. 5, by setting the maximum order K to 2, a first-order coefficient (a_{0,1}) to 2, and a second-order coefficient (a_{0,2}) to −1. In this case, the first polynomial item matrix filter f(P̅_{f},0) may be obtained as 2P̅_{f}−P̅²_{f}.

Further, for Location, a second polynomial item matrix filter f(P̅_{f},1) may be set to have a linear-type frequency response function (h(λ)=1−λ)), as shown in (B) of FIG. 5, by setting both the maximum order K and the first-order coefficient (a_{1,1}) to 1. In this case, the second polynomial item matrix filter f(\tilde{P}_{f},1) may be obtained as \tilde{P}_{f}. That is, the adjusted inter-item similarity matrix P̅_{f} itself may be set as the second polynomial item matrix filter f(P̅_{f},1).

Meanwhile, for Cleanliness, a third polynomial item matrix filter f(\tilde{P}_{f},2) may be be set to have an inward-type frequency response function (h(λ)=λ²−2λ−1), as shown in (C) of FIG. 5, by setting the maximum order K to 2 and the second-order coefficient (a_{2,2}) to 2. In this case, the third polynomial item matrix filter f(\tilde{P}_{f},2) may be obtained as \tilde{P}²_{f}.

In addition, the item filter setting module 33 may search for a maximum order K and order-specific coefficients (a_{c,k}) such that the frequency response function (h(λ)) of Equation 8 has a form corresponding to a low-pass filtering characteristic required for a criterion-specific polynomial item matrix filter f(P̅_{f,c}), and may set the criterion-specific polynomial item matrix filter f(P̅_{f,c}) according to Equation 7 using the searched maximum order and the order-specific coefficients (a_{c,k}).

The item filter setting module 33 may search for and set the maximum order K and the order-specific coefficients (a_{c,k}) over a wide range. That is, a large number of polynomial item matrix filters f(P̅_{f,c}) having various low-pass filtering characteristics may be set. However, in order to reduce computational cost, the item filter setting module 33 may designate and store a plurality of polynomial item matrix filters f(P̅_{f,c}) having preset maximum orders K and order-specific coefficients (a_{c,k}), and may be configured to select one of the plurality of designated criterion-specific polynomial item matrix filters f(P̅_{f,c}) for each evaluation criterion (c).

For example, as shown in FIG. 5, three polynomial item matrix filters f(P̅_{f,c}) may be preset and stored in advance, and the item filter setting module 33 may be configured to select one of the three stored polynomial item matrix filters f(P̅_{f,c}) according to the evaluation criterion (c).

An adjustment parameter (s_{f}) corresponding to each of the designated polynomial item matrix filters f(P̅_{f,c}) may also be preset and matched thereto. That is, according to the polynomial item matrix filter f(P̅_{f,c}) selected by the item filter setting module 33, a matched adjustment parameter (s_{f}) may be selected together, and an adjusted inter-item similarity matrix \tilde{P}_{f} may be obtained.

When the criterion-specific polynomial item matrix filter f(P̅_{f,c}) is obtained by the item filter setting module 33, a predicted rating (s_{u,c}) of a user (u) for a specific evaluation criterion (c) may be obtained according to Equation 9 using the obtained criterion-specific polynomial item matrix filter f(P̅_{f,c}).

s_{u,c}=r_{u,c}f(P̅_{f},c) (9)

Here, r_{u,c} denotes a vector composed of ratings of a user (u) for a plurality of items with respect to an evaluation criterion (c), and corresponds to a u-th row vector of a criterion-specific evaluation matrix R_{c}.

In this embodiment, the multi-criteria recommendation apparatus may identify a predetermined number of top-ranked items having the largest values among the predicted ratings (s_{u,c}) of Equation 9 and recommend the identified items to the user. However, in Equation 9, a user's preference for each evaluation criterion (c) is not considered. That is, in the aggregation process of FIG. 5, the user's preference for evaluation criteria is not reflected. Each user may assign different levels of importance to different evaluation criteria. For example, a first user may place more importance on Location, whereas a second user may place more importance on Cleanliness. However, in Equation 9, the importance of each evaluation criterion (c) is equally reflected, and thus user-specific preferences for evaluation criteria are not applied.

Accordingly, in this embodiment, the multi-criteria recommendation apparatus may obtain a filtered inter-criterion similarity matrix Ć for obtaining a predicted rating (sᵤ) in which a user-specific preference for each evaluation criterion (c) is reflected, by using a multi-criteria similarity matrix acquisition module 40 and a preference filter module 50.

The multi-criteria similarity matrix acquisition module 40 obtains, from multi-criteria evaluation data collected by the multi-criteria data acquisition module 10, an inter-criterion similarity matrix T representing similarities among preferences for respective evaluation criteria.

The multi-criteria similarity matrix acquisition module 40 may include a multi-criteria preference matrix generation module 41 and an inter-criterion similarity matrix generation module 43. The multi-criteria preference matrix generation module 41 generates a multi-criteria preference matrix X having a size of [symbol] ^{|U|×(C+1)} by receiving multi-criteria evaluation data and calculating, for each user (u₁, u₂, . . . ), a sum of ratings assigned to a plurality of items (i₁, i₂, i₃, . . . ) for each evaluation criterion (c).

The multi-criteria preference matrix X may be generated according to Equation 10 based on (C+1) criterion-specific evaluation matrices (R₀, R₁, . . . , R_{C}), each corresponding to an evaluation criterion (c), in which a plurality of users (u₁, u₂, . . . ) evaluate a plurality of items items (i₁, i₂, i₃, . . . ).

X=(R₀1)∥(R₁1)∥ . . . (R_{C}1) (10)

Here, 1 denotes a column vector having a length of |U|, corresponding to the number of users U, for criterion-specific evaluation matrices (R₀, R₁, . . . , R_{C}), each having a size of [symbol] ^{|} [symbol] ^{|×|} [symbol] ^{|}), and ∥ denotes a concatenation function.

That is, a total rating assigned by each user (u₁, u₂, . . . ) for each evaluation criterion (c) is calculated regardless of items (i₁, i₂, i₃, . . . ), thereby generating the multi-criteria preference matrix X. An evaluation criterion to which a user has assigned a higher total rating is regarded as an evaluation criterion preferred by the user. Accordingly, the multi-criteria preference matrix X may be regarded as a matrix representing a level of preference of each user for each evaluation criterion.

Further, similarly to the multi-criteria rating matrix generation module 21, the multi-criteria preference matrix generation module 41 may perform normalization on the multi-criteria preference matrix X according to Equation 11 to obtain a normalized multi-criteria preference matrix \tilde{X}.

$$\tilde{X} = {XD}_{X}^{- 1} X \qquad ( 11 )$$

Here, D_{X}⁻¹ may be obtained as D_{X}⁻¹=diag(X1), where D_{X}⁻¹ denotes a vector composed of diagonal elements of the multi-criteria preference matrix X, and l denotes a vector having elements all equal to 1.

In some cases, the multi-criteria preference matrix generation module 41 may not perform normalization on the multi-criteria rating matrix R_{MC}.

The inter-criterion similarity matrix generation module 43 receives the normalized multi-criteria preference matrix \tilde{X}, and obtains, according to Equation 12, an inter-criterion similarity matrix T representing similarities among preferences for respective evaluation criteria.

T=\tilde{X}^{T}\tilde{X} (12)

Since the normalized multi-criteria preference matrix/has a size of [symbol] ^{|U|×(C+1)}, an inter-criterion similarity matrix T representing similarities among preferences for evaluation criteria is obtained as a matrix having a size of [symbol] ^{(C+1)×(C+1)}. The inter-criterion similarity matrix T may also be transformed into an inter-criterion similarity graph, similar to (C) of FIG. 3, in which a plurality of evaluation criteria constitute nodes and weights of edges connecting the nodes represent mutual similarities.

The preference filter module 50 receives the inter-criterion similarity matrix T to set a preference filter T̅, and filters the normalized multi-criteria preference matrix \tilde{X} using the set preference filter T̅ to obtain a filtered inter-criterion similarity matrix Ć. The preference filter module 50 may include a preference smoothness adjustment module 51 and a preference filtering module 53.

The preference smoothness adjustment module 51 may smooth the inter-criterion similarity matrix T according to Equation 13 to obtain an adjusted inter-criterion similarity matrix T̅ in a manner similar to that in which the item smoothness adjustment module 31 smooths the inter-item similarity matrix \tilde{P}_{MC} to obtain the adjusted inter-item similarity matrix \tilde{P}_{f}.

$${\overline{T}}_{ij} = {T}_{ij}^{{s}_{f}} \qquad ( 13 )$$

Here, ij denotes an element at position (i,j) of the inter-criterion similarity matrix T and the adjusted inter-criterion similarity matrix T̅, and s_{f} denotes an adjustment parameter.

The adjusted inter-criterion similarity matrix T̅ obtained by the preference smoothness adjustment module 51 may be used as it is as a criterion preference filter.

Accordingly, as shown in Equation 14, the preference filtering module 53 may obtain a filtered inter-criterion similarity matrix Ć by multiplying the normalized multi-criteria preference matrix \tilde{X} by the adjusted inter-criterion similarity matrix T̅ to thereby filter the normalized multi-criteria preference matrix \tilde{X}.

Ĉ=\tilde{X}T̅ (14)

Here, the filtered inter-criterion similarity matrix Ć may be regarded as a matrix in which different weights are reflected according to a preference of each user for each evaluation criterion (c).

The item recommendation module 60 receives the criterion-specific polynomial item matrix filter f(P̅_{i,c}) from the item filter module 30, and receives the filtered inter-criterion similarity matrix Ć from the preference filter module 50. The item recommendation module 60 may obtain, according to Equation 15, a final predicted rating (sᵤ), in which a user-specific preference for each evaluation criterion (c) is reflected across all evaluation criteria (c), based on the obtained criterion-specific polynomial item matrix filter f(P̅_{f,c}) and the filtered inter-criterion similarity matrix Ć.

$${s}_{u} = \frac{1}{C + 1} {\sum }_{c = 0}^{C} {\hat{C}}_{u , c} {s}_{u , c} = \frac{1}{C + 1} {\sum }_{c = 0}^{C} \text{?} {r}_{u , c} f ( \text{?} , c ) \qquad ( 15 )$$

$$\text{?} \text{indicates text missing or illegible when filed}$$

Here, s_{u,c} denotes a predicted rating of a user (u) for each evaluation criterion (c), and r_{u,c} denotes a vector composed of ratings of the user (u) for a plurality of items with respect to the evaluation criterion (c), corresponding to a u-th row vector of a criterion-specific evaluation matrix R_{c}.

The item recommendation module 60 may identify a predetermined number of top-ranked items having the highest final predicted ratings (sᵤ) calculated according to Equation 15, and recommend the identified items to the user.

As a result, in this embodiment, the multi-criteria recommendation apparatus obtains, through matrix operations, final predicted ratings (sᵤ) of items for each user (u) and each evaluation criterion (c) by using the inter-criterion similarity matrix Ć, which reflects user preferences for evaluation criteria, and the criterion-specific polynomial item matrix filter f(P̅_{f,c}). Accordingly, by recommending items based on the obtained final predicted ratings (sᵤ), accurate recommendations reflecting user preferences may be provided. Further, since neural network operations are not performed, separate prior training is not required, and since eigendecomposition for graph filtering is also not required, items may be recommended quickly with low computational complexity.

In the illustrated embodiment, each component may have functions and capabilities different from those described above, and may further include additional components not described herein. In addition, in an embodiment, each component may be implemented using one or more physically separated devices, or may be implemented by one or more processors or a combination of one or more processors and software, and may not be clearly distinguished in specific operations, unlike the illustrated example.

Further, the multi-criteria recommendation apparatus illustrated in FIG. 2 may be implemented in a logic circuit by hardware, firmware, software, or a combination thereof, and may also be implemented using a general-purpose computer or a special-purpose computer. The apparatus may be implemented using a hardwired device, a Field Programmable Gate Array (FPGA), an Application Specific Integrated Circuit (ASIC), or the like. In addition, the apparatus may be implemented as a System on Chip (SoC) including one or more processors and controllers.

In addition, the multi-criteria recommendation apparatus may be mounted on a computing device or a server having hardware elements in the form of software, hardware, or a combination thereof. The computing device or server may refer to various devices including, in whole or in part, a communication device such as a communication modem for performing communication with various devices or wired/wireless communication networks, a memory for storing data for executing programs, and a microprocessor for executing programs to perform operations and control.

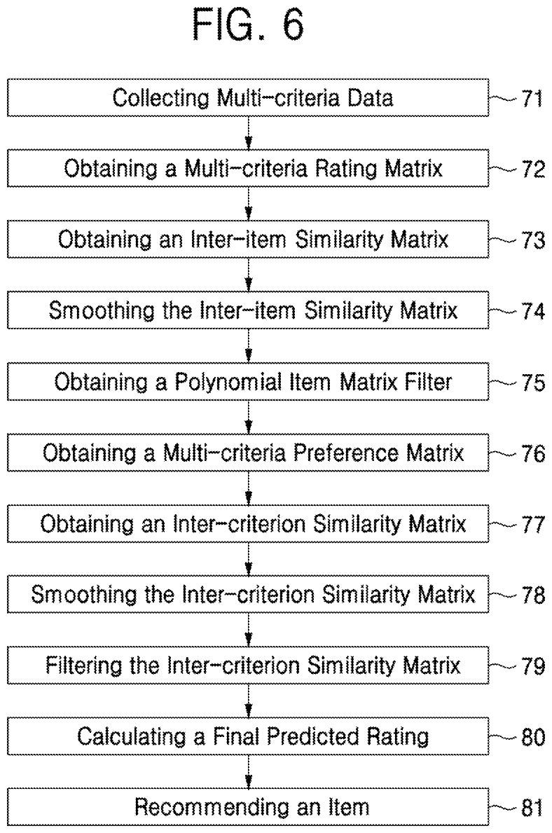

FIG. 6 illustrates a multi-criteria recommendation method according to one embodiment.

Referring to FIG. 6, in an embodiment, a multi-criteria recommendation method first collects multi-criteria evaluation data in which a plurality of users (Users) evaluate a plurality of items (Items) according to a plurality of evaluation criteria (criteria) in step 71. Then, from the multi-criteria evaluation data, criterion-specific evaluation matrices (R₀, R₁, . . . , R_{C}) are generated, in which a plurality of users (u₁, u₂, . . . ) evaluate a plurality of items (i₁, i₂, i₃, . . . ) for each evaluation criterion (c), and the generated matrices are combined to obtain a multi-criteria rating matrix R_{MC} in step 72. Accordingly, the multi-criteria rating matrix R_{MC} comprises rating scores for a plurality of items evaluated according to multiple evaluation criteria.

When the multi-criteria rating matrix R_{MC} is obtained, an inter-item similarity matrix \tilde{P}_{MC} is obtained by performing a matrix multiplication of the transpose of the multi-criteria rating matrix R_{MC} and the multi-criteria rating matrix R_{MC} in step 73. In some cases, the multi-criteria rating matrix R_{MC} may be normalized to obtain a normalized multi-criteria rating matrix \tilde{R}_{MC}, and the inter-item similarity matrix \tilde{P}_{MC} may be obtained using the normalized multi-criteria rating matrix \tilde{R}_{MC}.

When the inter-item similarity matrix \tilde{P}_{MC} is obtained, the inter-item similarity matrix \tilde{P}_{MC} is smoothed by performing a Hadamard power operation according to an adjustment parameter (s_{f}), thereby obtaining an adjusted inter-item similarity matrix P̅_{f} having a smoothed distribution of element values in step 74.

Further, from the adjusted inter-item similarity matrix \tilde{P}_{f}, a criterion-specific polynomial item matrix filter f(P̅_{f,c}) set according to Equation 7 is obtained by searching for a maximum order K and order-specific coefficients (a_{c,k}) of a matrix polynomial such that the criterion-specific polynomial item matrix filter f(P̅_{f,c}) has a required low-pass filtering characteristic in step 75.

In this case, the polynomial item matrix filter f(P̅_{f,c}) may be obtained by searching for the maximum order (K) and the order-specific coefficients (a_{c,k}) such that a frequency response (h(λ)) according to Equation 8, based on eigenvalues ({λ₁, λ₂, . . . , λ_{|V|}}) of a normalized graph Laplacian matrix \tilde{L} for the adjusted inter-item similarity matrix \tilde{P}_{f} has the required low-pass filtering characteristic. In some cases, a plurality of required low-pass filtering characteristics for respective criteria may be predefined, and, for each of the plurality of low-pass filtering characteristics, corresponding maximum orders (K) and order-specific coefficients (a_{c,k}) may be preset, such that a plurality of criterion-specific polynomial item matrix filters f(P̅_{f,c}) are preset in advance. In this case, one of the plurality of preset criterion-specific polynomial item matrix, filters f(P̅_{f,c}) may be selected and obtained according to each evaluation criterion.

Meanwhile, from the multi-criteria evaluation data, a multi-criteria preference matrix X is obtained by calculating, for each user (u₁, u₂, . . . ), a sum of ratings assigned to a plurality of items (i₁, i₂, i₃, . . . ) for each evaluation criterion (c) in step 76. That is, each user (u₁, u₂, . . . ) generates the multi-criteria preference matrix X by calculating total ratings assigned to each evaluation criterion (c) regardless of items (i₁, i₂, i₃, . . . ).

Further, an inter-criterion similarity matrix T representing similarities among preferences for evaluation criteria is obtained by multiplying the transpose of the multi-criteria preference matrix X and the multi-criteria preference matrix X in step 77. In this case, the multi-criteria preference matrix X may first be normalized according to Equation 11, and the inter-criterion similarity matrix T may be obtained using the normalized multi-criteria preference matrix X.

When the inter-criterion similarity matrix T is obtained, the inter-criterion similarity matrix T is smoothed to obtain an adjusted inter-criterion similarity matrix T̅ in step 78. Here again, the adjusted inter-criterion similarity matrix T̅ may be obtained by performing a Hadamard power operation in which each element of the inter-criterion similarity matrix T is raised to a power corresponding to an adjustment parameter (s_{f}).

When the adjusted inter-criterion similarity matrix T̅ is obtained, the normalized multi-criteria preference matrix \tilde{X} is filtered using the adjusted inter-criterion similarity matrix T̅ to obtain a filtered inter-criterion similarity matrix Ć in step 79. Herethe filtered inter-criterion similarity matrix \tilde{C} may be obtained as a matrix product of the normalized multi-criteria preference matrix \tilde{X} and the adjusted inter-criterion similarity matrix T̅.

Here, an order in which a step 72 of obtaining the multi-criteria rating matrix R_{MC} to a step 75 of obtaining the criterion-specific polynomial item matrix filter f(P̅_{f,c}), and a step 76 of obtaining the multi-criteria preference matrix X to a step 79 of obtaining the filtered inter-criterion similarity matrix Ć, are performed may be interchanged with each other or may be performed in parallel.

When the criterion-specific polynomial item matrix filter f(P̅_{f,c}) and the filtered inter-criterion similarity matrix Ć are obtained, as shown in Equation 15, a product of the inter-criterion similarity matrix Ć, a rating vector (r_{u,c}) of a user (u) for a plurality of items with respect to each evaluation criterion (c), and the criterion-specific polynomial item matrix filter f(P̅_{f,c}) is cumulatively averaged for each evaluation criterion (c), thereby calculating a final predicted rating (sᵤ) in which a preference of the user (u) for each evaluation criterion (c) is reflected across all evaluation criteria in step 80.

Then, a predetermined number of top-ranked items having the highest final predicted ratings (sᵤ) are identified and recommended to the user in step 81.

Although FIG. 6 illustrates that respective steps are performed sequentially, this is merely for illustrative purposes. Those skilled in the art will appreciate that the order of the steps illustrated in FIG. 6 may be modified within a scope not departing from the essential characteristics of the present embodiment, that two or more steps may be performed in parallel, and/or that additional steps may be added.

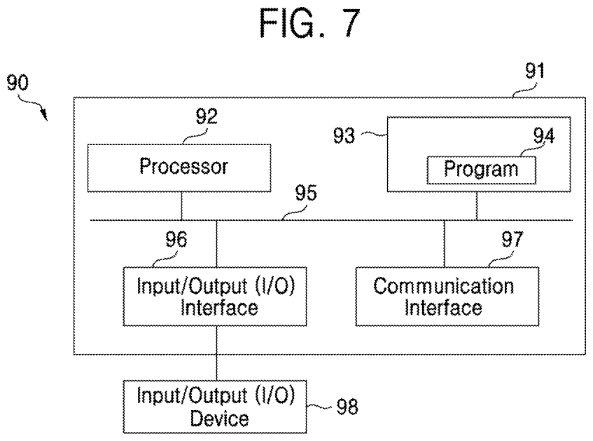

FIG. 7 is a diagram for explaining a computing environment including a computing device according to an embodiment.

In the illustrated embodiment, each component may have functions and capabilities different from those described below, and may further include additional components other than those described below. The illustrated computing environment 90 includes a computing device 91 capable of performing the multi-criteria recommendation method shown in FIG. 6. In an embodiment, the computing device 91 may correspond to, or include, one or more components of the multi-criteria recommendation apparatus shown in FIG. 2.

The computing device 91 includes at least one processor 92, a computer-readable storage medium 93, and a communication bus 95. The processor 92 may cause the computing device 91 to operate according to the exemplary embodiments described above. For example, the processor 92 may execute one or more programs 94 stored in the computer-readable storage medium 93. The one or more programs 94 may include one or more computer-executable instructions, which, when executed by the processor 92, cause the computing device 91 to perform operations according to the exemplary embodiments.

The communication bus 95 interconnects various other components of the computing device 91, including the processor 92 and the computer-readable storage medium 93.

The computing device 91 may further include one or more input/output interfaces 96 for providing an interface for one or more input/output devices 98, and one or more communication interfaces 97. The input/output interfaces 96 and the communication interfaces 97 are connected to the communication bus 95. The input/output devices 98 may be connected to other components of the computing device 91 through the input/output interfaces 96.

Exemplary input/output devices 98 may include input devices such as a pointing device (e.g., a mouse or a trackpad), a keyboard, a touch input device (e.g., a touchpad or a touchscreen), a voice or sound input device, various types of sensor devices, and/or an imaging device, and/or output devices such as a display device, a printer, a speaker, and/or a network card. The exemplary input/output devices 98 may be included inside the computing device 91 as components constituting the computing device 91, or may be connected to the computing device 91 as separate devices distinguished from the computing device 91.

Accordingly, the multi-criteria recommendation method and apparatus according to an embodiment employ a multi-criteria graph filtering technique, thereby enabling rapid real-time recommendation with low computational complexity while providing higher user satisfaction and recommendation accuracy than a single-criterion recommendation scheme.

While the present invention has been described in detail above with reference to representative embodiments, those skilled in the art will understand that various modifications and equivalent embodiments may be made thereto. Accordingly, the true technical scope of the present invention should be defined by the technical spirit of the appended claims.

What is claimed is:

1. A multi-criteria recommendation method performed by a computing device, the method comprising:
obtaining, from multi-criteria evaluation data including ratings assigned by a user to items according to a plurality of evaluation criteria, a multi-criteria rating matrix composed of user-item ratings for each of the plurality of evaluation criteria;
obtaining, from the multi-criteria rating matrix, an inter-item similarity matrix representing relationships among the items;
obtaining an adjusted inter-item similarity matrix having a smoothed distribution of element values by performing a Hadamard power operation on the inter-item similarity matrix;
setting, for each of the plurality of evaluation criteria, a criterion-specific polynomial item matrix filter having a polynomial form with respect to the adjusted inter-item similarity matrix;
obtaining, from a multi-criteria preference matrix obtained from sums of ratings assigned by the user to a plurality of items for each of the plurality of evaluation criteria, a filtered inter-criterion similarity matrix in which similarities among evaluation criteria preferred by the user are filtered; and
obtaining a final predicted rating by cumulatively summing products, for each of the plurality of evaluation criteria, of a user rating vector constituting one row of the multi-criteria rating matrix, the criterion-specific polynomial item matrix filter, and the filtered inter-criterion similarity matrix, and recommending one or more items based on the final predicted rating.

2. The method of claim 1, wherein the multi-criteria rating matrix is obtained by generating a plurality of criterion-specific evaluation matrices composed of ratings assigned by a plurality of users to respective items for respective evaluation criteria in the multi-criteria evaluation data, and combining the plurality of criterion-specific evaluation matrices.

3. The method of claim 1, wherein the inter-item similarity matrix is obtained by a matrix multiplication of a transpose of the multi-criteria rating matrix and the multi-criteria rating matrix.

4. The method of claim 1, wherein the adjusted inter-item similarity matrix is obtained by raising each element of the inter-item similarity matrix to power of an adjustment parameter designated according to the criterion-specific polynomial item matrix filter.

5. The method of claim 1, wherein the criterion-specific polynomial item matrix filter is set by searching for a maximum order such that a frequency response function has a low-pass filtering characteristic required for each criterion and coefficients for respective orders.

6. The method of claim 1, wherein the criterion-specific polynomial item matrix filter is set by selecting, from among a plurality of preset polynomial item matrix filters, a polynomial item matrix filter having a frequency response function with a required low-pass filtering characteristic.

7. The method of claim 1, wherein obtaining the filtered inter-criterion similarity matrix comprises:
obtaining, from the multi-criteria evaluation data, a multi-criteria preference matrix calculated from sums of ratings assigned by the user to a plurality of items for respective evaluation criteria;
obtaining, from the multi-criteria preference matrix, an inter-criterion similarity matrix representing similarities among preferences of the user for the evaluation criteria;
obtaining an adjusted inter-criterion similarity matrix by performing a Hadamard power operation on the inter-criterion similarity matrix; and
obtaining the filtered inter-criterion similarity matrix by multiplying the multi-criteria rating matrix and the adjusted inter-criterion similarity matrix.

8. The method of claim 7, wherein the multi-criteria preference matrix is obtained by multiplying each of a plurality of criterion-specific evaluation matrices, each composed of ratings assigned by a plurality of users to respective items for respective evaluation criteria in the multi-criteria evaluation data, by a vector composed of all ones, and combining resulting matrices.

9. The method of claim 1, wherein the multi-criteria recommendation method is performed by a processor of an apparatus including a memory and the processor.

10. A multi-criteria recommendation apparatus comprising:
a memory; and
a processor configured to execute at least some operations according to a program stored in the memory,
wherein the processor is configured to:
obtain, from multi-criteria evaluation data including ratings assigned by a user to items according to a plurality of evaluation criteria, a multi-criteria rating matrix composed of user-item ratings for each of the plurality of evaluation criteria;
obtain, from the multi-criteria rating matrix, an inter-item similarity matrix representing relationships among items;
obtain an adjusted inter-item similarity matrix having a smoothed distribution of element values by performing a Hadamard power operation on the inter-item similarity matrix;
set, for each of the plurality of evaluation criteria, a criterion-specific polynomial item matrix filter having a polynomial form with respect to the adjusted inter-item similarity matrix; obtain, from a multi-criteria preference matrix obtained from sums of ratings assigned by the user to a plurality of items for each of the plurality of evaluation criteria, a filtered inter-criterion similarity matrix in which similarities among evaluation criteria preferred by the user are filtered; and
obtain a final predicted rating by cumulatively summing products, for each of the plurality of evaluation criteria, of a user rating vector constituting one row of the multi-criteria rating matrix, the criterion-specific polynomial item matrix filter, and the filtered inter-criterion similarity matrix, and recommend one or more items based on the final predicted rating.

11. The apparatus of claim 10, wherein the multi-criteria rating matrix is obtained by generating a plurality of criterion-specific evaluation matrices composed of ratings assigned by a plurality of users to respective items for respective evaluation criteria in the multi-criteria evaluation data, and combining the plurality of criterion-specific evaluation matrices.

12. The apparatus of claim 10, wherein the inter-item similarity matrix is obtained by a matrix multiplication of a transpose of the multi-criteria rating matrix and the multi-criteria rating matrix.

13. The apparatus of claim 10, wherein the adjusted inter-item similarity matrix is obtained by raising each element of the inter-item similarity matrix to power of an adjustment parameter designated according to the criterion-specific polynomial item matrix filter.

14. The apparatus of claim 10, wherein the criterion-specific polynomial item matrix filter is set by searching for a maximum order and coefficients for respective orders such that a frequency response function has a low-pass filtering characteristic required for each criterion.

15. The apparatus of claim 10, wherein the criterion-specific polynomial item matrix filter is set by selecting, from among a plurality of preset polynomial item matrix filters, a polynomial item matrix filter having a frequency response function with a required low-pass filtering characteristic.

16. The apparatus of claim 10, wherein the filtered inter-criterion similarity matrix is obtained by:
obtaining, from the multi-criteria evaluation data, a multi-criteria preference matrix calculated from sums of ratings assigned by the user to a plurality of items for respective evaluation criteria;
obtaining, from the multi-criteria preference matrix, an inter-criterion similarity matrix representing similarities among preferences of the user for the evaluation criteria; obtaining an adjusted inter-criterion similarity matrix by performing a Hadamard power operation on the inter-criterion similarity matrix; and
multiplying the multi-criteria rating matrix and the adjusted inter-criterion similarity matrix.

17. The apparatus of claim 16, wherein the multi-criteria preference matrix is obtained by multiplying each of a plurality of criterion-specific evaluation matrices, each composed of ratings assigned by a plurality of users to respective items for respective evaluation criteria in the multi-criteria evaluation data, by a vector composed of all ones, and combining resulting matrices.
